(19) United States
(12) Patent Application Publication
(10) Pub. No.: US 2002/0095838 A1
(43) Pub. Date: Jul. 25, 2002

(54) Novelty display item

(75) Inventor: Shing-Wah Yu, Kowloon (CN)

Correspondence Address: ALIX YALE & RISTAS LLP, 750 MAIN STREET, SUITE 1400, HARTFORD, CT, 06103, US

(73) Assignee: Golden Peak Plastic Works Limited

(21) Appl. No.: 09/727,959

(22) Filed: Dec. 1, 2000

(51) Int. Cl. G09F 19/00; G09F 13/22

(52) U.S. Cl. 40/544; 40/409

(57) ABSTRACT

A table top novelty display item consist of a liquid filled chamber having a transparent curved front wall 10 and a transparent rear wall 11. An electro-luminescent display panel 15 is driven by an electrical circuit 16 to produce a varying visual effect. The item includes a music chip 18 and a loudspeaker 19.

### BACKGROUND OF THE INVENTION

1. Field of the Invention

The invention relates to novelty display items.

2. Description of Prior Art

The invention relates more particularly to table top novelty display items having a liquid-filled shell. Such display items are well-known and typically have a statuette or other objects contained behind a transparent wall of a liquid-tight chamber. Particulate may be contained in the liquid, which is usually water, that may be agitated to give effect of swirling snow. A rear of the chamber may be painted or otherwise provided with decorative coloring that may depict a static scene or back drop for the statuette. As such the item globe is relatively unappealing or at least unlikely to maintain a viewer's interest except over a short period of time.

### SUMMARY OF THE INVENTION

It is an object of the invention to overcome or at least reduce this problem.

According to the invention there is provided a table top novelty display item having a liquid-tight walled chamber arranged to contain liquid inside the wall of the chamber, in which the chamber has a transparent front wall and a transparent planar rear wall, an electro-luminescent display panel mounted to an outer surface of the rear wall, a housing for supporting the chamber, and an electrical drive circuit mounted inside the housing arranged to supply electrical power to the display panel.

The front wall is preferably semi-circular in cross-section.

The housing may include a hollow base stand below the chamber and the drive circuit be mounted in the base stand.

A music chip may be mounted in the base stand and electrically coupled to a loudspeaker located inside the housing.

A battery compartment may be incorporated in the base stand.

### BRIEF DESCRIPTION OF THE DRAWINGS

A table top novelty display item according to the invention will now be described by way of example with reference to the accompany drawings in which:

FIG. 1 is an isometric exploded view of the item;

FIG. 2 is an isometric assembled view of the item; and

FIG. 3 is a bottom plan of the item.

### DESCRIPTION OF THE PREFERRED EMBODIMENT

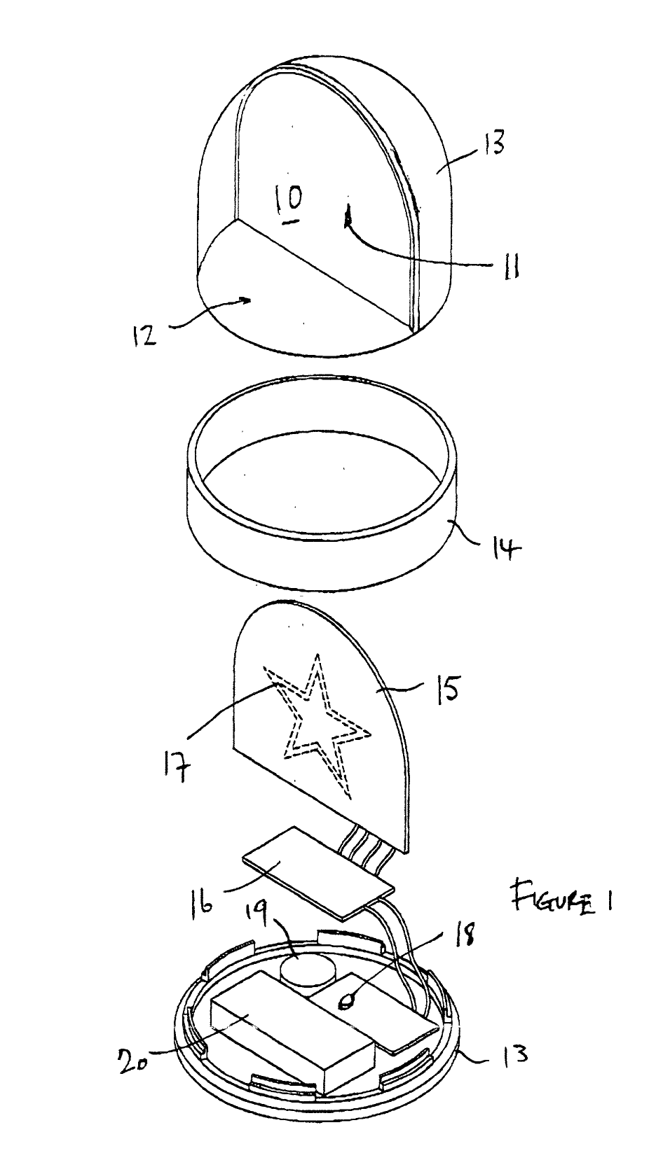

Referring to the drawings, in FIG. 1 the item has a liquid-tight walled chamber having a transparent front wall 10 that is semi-circular is cross-section and a planar transparent rear wall 11. The chamber is sealed off by a semi-circular base 12. In use, the chamber is filled with water.

The item has housing comprising rear cover plate 13, a circular base stand 14 and a base cover 13. An electro-luminescent display panel 15 fits against an outside surface of the rear wall 11 and is supplied from a drive circuit 16 mounted inside the base stand 14. The panel 15 is formed with a central star configuration 17 which in use is caused to be illuminated by the drive circuit 16 in different colors and/or intermittently in a manner well-understood in the art.

A music chip 18 mounted in the base stand is arranged to supply signals to a loudspeaker 19 for generating music when electrical power is supplied to the drive circuit 16. A battery compartment 20 is integrally formed in the cover 13.

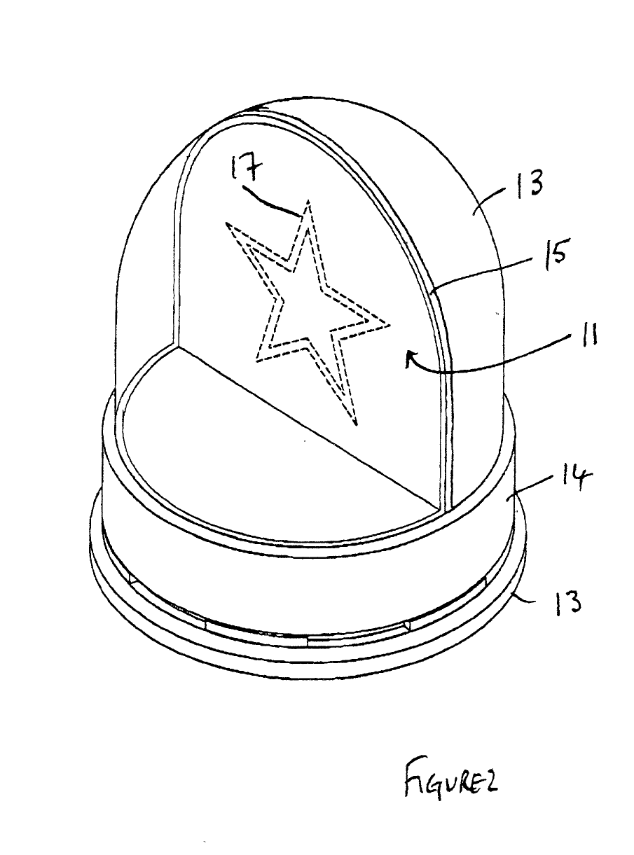

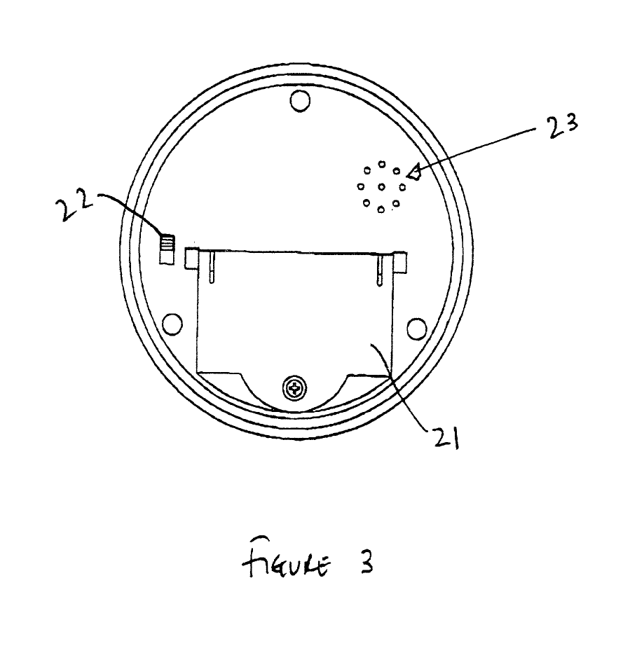

FIGS. 2 and 3 show the various parts of the item and in FIG. 3 a battery compartment lid 21, an ON-OFF switch 22 and apertures 23 for the loudspeaker are shown.

The chamber which may contain statuettes or similar and particulate (for a snow effect), is viewed from the front and a back drop which may be a Christmas scene, say, is provided by the panel 15. The panel is intermittently or randomly illuminated when the switch 22 is turned ON to generate a varying visual effect so as to retain the attention of an observer. At the same time, accompanying and appropriate music is played to further attract of the attention of the observer.

The item may be made as a partially utility item, in which case the rear cover plate 13 is formed with open shelves or cavities for storage of desk articles, such as pencils, paper clips, erasers and the like.

I claim:

1. A table top novelty display item having a liquid-tight walled chamber arranged to contain liquid inside the wall of the chamber, in which the chamber has a transparent front wall and a transparent planar rear wall, an electro-luminescent display panel mounted to an outer surface of the rear wall, a housing for supporting the chamber, and an electrical drive circuit mounted inside the housing arranged to supply electrical power to the display panel.

2. A table top novelty display item according to claim 1, in which the front wall is semi-circular in cross-section.

3. A table top novelty display item according to claim 1, in which the housing includes a hollow base stand below the chamber and the drive circuit is mounted in the base stand.

4. A table top novelty display item according to claim 3, including a music chip mounted in the base stand and electrically coupled to a loudspeaker inside the housing.

5. A table top novelty display item according to claim 3, including a battery compartment incorporated in the base stand.
